(19) United States
(12) Patent Application Publication
(10) Pub. No.: US 2026/0353039 A1
(43) Pub. Date: Nov. 5, 2026

(54) WIRELESS COMMUNICATION METHOD AND COMMUNICATIONS DEVICE

(71) Applicant: QUECTEL WIRELESS SOLUTIONS CO., LTD., Shanghai (CN)

(72) Inventor: Qufang HUANG, Shanghai (CN)

(73) Assignee: QUECTEL WIRELESS SOLUTIONS CO., LTD., Shanghai (CN)

(21) Appl. No.: 19/484,724

(22) PCT Filed: Jan. 18, 2024
(86) PCT No.: PCT/CN2024/073084

§ 371 Date: Apr. 9, 2026

(51) Int. Cl. H04W 4/06; H04W 4/021; H04W 84/06

(52) U.S. Cl. CPC H04W 4/06; H04W 4/021; H04W 84/06

(57) ABSTRACT

Provided are a wireless communication method and a communications device. The wireless communication method includes: receiving, by a terminal device, first information transmitted by a base station, where the first information is used to indicate a first service area of a multicast or broadcast service. In embodiments of the present application, the base station may transmit the first information to the terminal device to indicate the first service area (such as a partial area of a cell) of the multicast or broadcast service, which is beneficial to accurate controlling of a data transmission range of the multicast or broadcast service.

### TECHNICAL FIELD

The present application relates to the field of communications technologies, and more specifically, to a wireless communication method and a communications device.

### BACKGROUND

In order to control a data transmission range of a multicast or broadcast service, a wireless cellular network introduces a concept of a service area (service area) of the multicast or broadcast service. In related technologies, a service area is usually represented by a cell list. Correspondingly, a base station may perform data transmission of the multicast or broadcast service in cells indicated by the service area.

However, some cells have relatively large coverage, such as non-terrestrial network (NTN) cells, whose diameter may reach hundreds of kilometers or even thousands of kilometers. The service area of the multicast or broadcast service may be a partial area of a cell (for example, the service area of the multicast or broadcast service is smaller than coverage of an NTN cell). If the foregoing transmission manner of the multicast or broadcast service is used, the base station performs data transmission of the multicast or broadcast service within a range of a cell (such as the NTN cell), which may cause the data transmission range of the multicast or broadcast service to be inaccurate.

### SUMMARY

The present application provides a wireless communication method and a communications device. Various aspects involved in the present application are described below.

According to a first aspect, a wireless communication method is provided. The method includes: receiving, by a terminal device, first information transmitted by a base station, where the first information is used to indicate a first service area of a multicast or broadcast service.

According to a second aspect, a wireless communication method is provided. The method includes: transmitting, by a base station, first information to a terminal device, where the first information is used to indicate a first service area of a multicast or broadcast service.

According to a third aspect, a wireless communication method is provided. The method includes: transmitting, by a core network device, second information to a base station, where the second information is used to indicate a service area of a multicast or broadcast service, and the first information is independent of a cell of the base station.

According to a fourth aspect, a communications device is provided. The communications device is a terminal device, and the communications device includes: a first receiving unit, receiving first information transmitted by a base station, where the first information is used to indicate a first service area of a multicast or broadcast service.

According to a fifth aspect, a communications device is provided. The communications device is a base station, and the communications device includes: a first transmitting unit, transmitting first information to a terminal device, where the first information is used to indicate a first service area of a multicast or broadcast service.

According to a sixth aspect, a communications device is provided. The communications device is a core network device, and the communications device includes: a transmitting unit, transmitting second information to a base station, where the second information is used to indicate a service area of a multicast or broadcast service, and the first information is independent of a cell of the base station.

According to a seventh aspect, a communications device is provided. The communications device includes a transceiver, a memory, and a processor, where the memory is configured to store a program, and the processor is configured to invoke the program in the memory, and control the transceiver to receive or transmit a signal, to cause the communications device to perform the method according to any one of the first aspect to the third aspect.

According to an eighth aspect, an apparatus is provided. The apparatus includes a processor, invoking a program from a memory, to cause the apparatus to perform the method according to any one of the first aspect to the third aspect.

According to a ninth aspect, a chip is provided. The chip includes a processor, invoking a program from a memory, to cause a device installed with the chip to perform the method according to any one of the first aspect to the third aspect.

According to a tenth aspect, a computer-readable storage medium is provided. The computer-readable storage medium stores a program, and the program causes a computer to perform the method according to any one of the first aspect to the third aspect.

According to an eleventh aspect, a computer program product is provided. The computer program product includes a program, where the program causes a computer to perform the method according to any one of the first aspect to the third aspect.

According to a twelfth aspect, a computer program is provided. The computer program causes a computer to perform the method according to any one of the first aspect to the third aspect.

In embodiments of the present application, the base station may transmit the first information to the terminal device to indicate the first service area (such as a partial area of a cell) of the multicast or broadcast service, which is beneficial to accurate controlling of a data transmission range of the multicast or broadcast service.

### BRIEF DESCRIPTION OF THE DRAWINGS

FIG. 1 is an example diagram of a system architecture of a wireless communications system to which an embodiment of the present application is applicable.

FIG. 2 is a schematic diagram of a procedure of initiating a multicast or broadcast service according to an embodiment of the present application.

FIG. 3 is a schematic flowchart of a wireless communication method according to an embodiment of the present application.

FIG. 4 is a schematic diagram of a service area according to an embodiment of the present application.

FIG. 5 is a schematic flowchart of a wireless communication method according to another embodiment of the present application.

FIG. 6 is a schematic flowchart of a wireless communication method according to still another embodiment of the present application.

FIG. 7 is a schematic flowchart of a wireless communication method according to yet another embodiment of the present application.

FIG. 8 is a schematic diagram of a structure of a communications device according to an embodiment of the present application.

FIG. 9 is a schematic diagram of a structure of a communications device according to another embodiment of the present application.

FIG. 10 is a schematic diagram of a structure of a communications device according to still another embodiment of the present application.

FIG. 11 is a schematic diagram of an apparatus to which an embodiment of the present application is applicable.

### DETAILED DESCRIPTION OF THE EMBODIMENTS

The technical solutions in the present application are described below with reference to the accompanying drawings.

### Communications System Architecture

FIG. 1 shows a wireless communications system 100 to which an embodiment of the present application is applied. The wireless communications system 100 may include a network device 110 and terminal devices 120. The network device 110 may be a device that communicates with the terminal devices 120. The network device 110 may provide communication coverage for a specific geographic area, and may communicate with a terminal device 120 located within the coverage area.

FIG. 1 exemplarily shows one network device and two terminals. Optionally, the wireless communications system 100 may include a plurality of network devices, and another quantity of terminal devices may be included within coverage range of each network device, which is not limited in embodiments of the present application.

Optionally, the wireless communications system 100 may further include other network entities such as a network controller and a mobility management entity. This is not limited in embodiments of the present application.

It should be understood that the technical solutions of embodiments of the present application may be applied to various communications systems, such as a 5^{th} generation (5G) system or a new radio (NR) system, a long term evolution (LTE) system, an LTE frequency division duplex (FDD) system, and an LTE time division duplex (TDD) system. The technical solutions provided in the present application may further be applied to a future communications system, such as a 6^{th} generation mobile communications system or a satellite communications system.

The terminal device in embodiments of the present application may also be referred to as a user equipment (UE), an access terminal, a subscriber unit, a subscriber station, a mobile site, a mobile station (MS), a mobile terminal (MT), a remote station, a remote terminal, a mobile device, a user terminal, a terminal, a wireless communications device, a user agent, or a user apparatus. The terminal device in embodiments of the present application may be a device providing a user with voice and/or data connectivity and capable of connecting people, objects, and machines, such as a handheld device or a vehicle-mounted device with a wireless connection function. The terminal device in embodiments of the present application may be a mobile phone, a tablet computer (Pad), a notebook computer, a palmtop computer, a mobile internet device (MID), a wearable device, a virtual reality (VR) device, an augmented reality (AR) device, a wireless terminal in industrial control (industrial control), a wireless terminal in self driving, a wireless terminal in remote medical surgery, a wireless terminal in smart grid, a wireless terminal in transportation safety, a wireless terminal in smart city, a wireless terminal in smart home, or the like. Optionally, the UE may be configured to function as a base station. For example, the UE may function as a scheduling entity, which provides a sidelink signal between UEs in V2X, D2D, or the like. For example, a cellular phone and a vehicle communicate with each other by using a sidelink signal. A cellular phone and a smart home device communicate with each other, without relaying of a communication signal through a base station.

The network device in embodiments of the present application may be a device for communicating with the terminal device. The network device may also be referred to as an access network device or a radio access network device. For example, the network device may be a base station. The network device in embodiments of the present application may be a radio access network (RAN) node (or device) that connects the terminal device to a wireless network. The base station may broadly cover the following various names, or may be interchangeable with the following names, such as a NodeB, an evolved NodeB (eNB), a next generation NodeB (gNB), a relay station, an access point, a transmitting and receiving point (TRP), a transmitting point (TP), a master eNode (MeNB), a secondary eNode (SeNB), a multi-standard radio (MSR) node, a home base station, a network controller, an access node, a radio node, an access point (AP), a transmission node, a transceiver node, a baseband unit (BBU), a remote radio unit (RRU), an active antenna unit (AAU), a remote radio head (RRH), a centralized unit (CU), a distributed unit (DU), and a positioning node. The base station may be a macro base station, a micro base station, a relay node, a donor node, or the like, or a combination thereof. Alternatively, the base station may be a communications module, a modem, or a chip disposed in the device or the apparatus described above. Alternatively, the base station may be a mobile switching center, a device that functions as a base station in device-to-device (D2D), vehicle-to-everything (V2X), and machine-to-machine (M 2M) communications, a network-side device in a 6G network, a device that functions as a base station in a future communications system, or the like. The base station may support networks with a same access technology or different access technologies. A specific technology and a specific device form used by the network device are not limited in embodiments of the present application.

The base station may be fixed or mobile. For example, a helicopter or an unmanned aerial vehicle may be configured to function as a mobile base station, and one or more cells may move according to a location of the mobile base station. In other examples, a helicopter or an unmanned aerial vehicle may be configured to function as a device in communication with another base station.

In some deployments, the network device in embodiments of the present application may be a centralized unit (CU) or a distributed unit (DU), or the network device includes a CU and a DU. The gNB may further include an AAU.

The network device and the terminal device may be deployed on land, including being indoors or outdoors, handheld, or vehicle-mounted, may be deployed on a water surface, or may be deployed on a plane, a balloon, or a satellite in the air. In embodiments of the present application, a scenario of the network device and the terminal device is not limited.

It should be understood that all or some of functions of the communications device in the present application may also be implemented by software functions running on hardware, or by virtualization functions instantiated on a platform (for example, a cloud platform).

### NTN

3GPP is currently studying NTN technologies. An NTN generally provides a terrestrial user with a communication service through satellite communication. The satellite communication has many unique advantages over terrestrial communication networks (such as a terrestrial cellular communication).

First, the satellite communication is not limited by a geographic location of a user. For example, a general terrestrial communication network cannot cover an area such as an ocean, a mountain, or a desert in which a network device cannot be set up. Alternatively, the terrestrial communication network cannot cover some areas where there is no communication coverage due to sparse population. However, for the satellite communication, since one satellite may cover a relatively large terrestrial area, and the satellite may orbit the earth, theoretically, every corner of the earth may be covered by a satellite communication network.

Second, the satellite communication has great social values. The satellite communication may cover remote mountainous areas, impoverished countries or regions at relatively low costs, thereby enabling people in these regions to enjoy advanced voice communication and mobile internet technologies. From this point of view, the satellite communication is conducive to narrowing a digital divide between these regions and developed regions and promoting development of these regions.

Third, the satellite communication has a long distance, and communication cost does not significantly increase with an increase in the communication distance.

Finally, the satellite communication has high stability, and is not affected by natural disasters.

Communications satellites are classified into low Earth orbit (low earth orbit, LEO) satellites, medium Earth orbit (medium earth orbit, MEO) satellites, geostationary Earth orbit (geostationary earth orbit, GEO) satellites, high elliptical orbit (high elliptical orbit, HEO) satellites, and the like depending on different orbital altitudes. At this stage, the main study is on the LEO satellite and the GEO satellite.

An altitude of the LEO satellite generally ranges from 500 km to 1500 km. Correspondingly, an orbital period of the LEO satellite is about 1.5 hours to 2 hours. For the LEO satellite, a signal propagation delay of single-hop communication between users is generally less than 20 ms. A maximum satellite visible time corresponding to the LEO satellite is about 20 minutes. The LEO satellite has advantages of a short signal propagation distance, a small link loss, and a low transmit power requirement for a terminal device.

An orbital altitude of the GEO satellite is about 35786 km. A period for the GEO satellite to rotate around the earth is 24 hours. For the GEO satellite, a signal propagation delay of single-hop communication between users is generally about 250 ms. An NTN system may include an NR NTN system and an IoT NTN system.

### Broadcast Service

A broadcast service may be understood as communication of one-to-any transmission, to be specific, one transmit end transmits a message to any receive end. In this case, an information source transmits data of a broadcast service through a broadcast channel, and any terminal device or network device within coverage of a broadcast signal may try to receive the data of the broadcast service.

### Multicast

A multicast service may be understood as communication of one-to-many transmission; to be specific, one transmit end transmits messages to a plurality of receive ends. In this case, an information source transmits data of a multicast service of a group through a multicast channel, and a terminal device or a network device that is within coverage of a multicast signal and that is a group member may try to receive data of the multicast service. When joining a group, a terminal device or network device may obtain multicast channel related resources. The multicast service may be referred to as multicast broadcast service (MBS) or multimedia broadcast multicast service (MBMS).

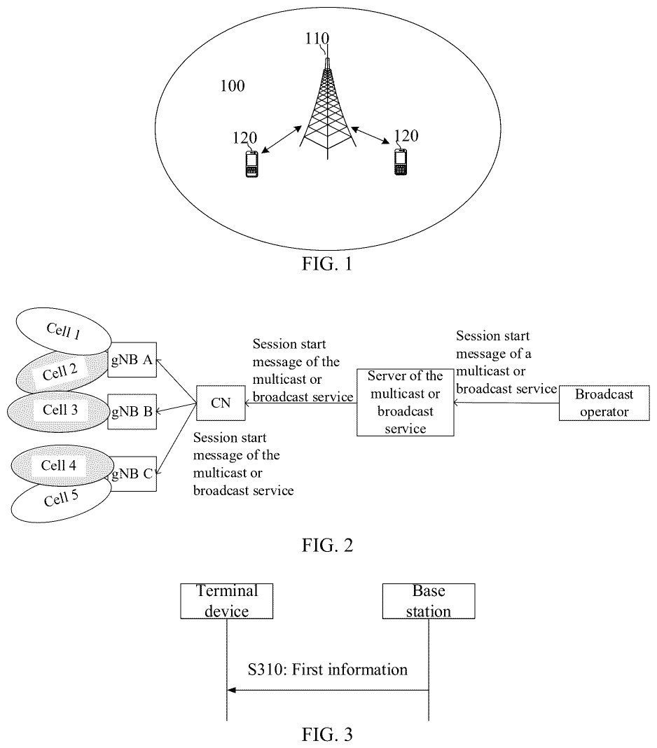

In order to control a data transmission range of a multicast or broadcast service, a wireless cellular network introduces a concept of a service area (service area) of the multicast or broadcast service. The service area of the multicast or broadcast service is usually represented by a plurality of cells. A base station may perform data transmission of the multicast or broadcast service in the cells corresponding to the service area of the multicast or broadcast service. It should be understood that an area of the service area of the multicast or broadcast service is usually much greater than an area covered by a TN cell. A diameter of a conventional TN cell is only a few hundred meters to a few kilometers. The service area of the multicast or broadcast service usually includes a plurality of TN cells. Therefore, the service area of the multicast or broadcast service may be represented by a plurality of cells. The following describes in detail a procedure of initiating a multicast or broadcast service with reference to FIG. 2.

As shown in FIG. 2, if a broadcast operator expects to start broadcasting a program, a session start (session start) message for a multicast or broadcast service may be transmitted. The message may include a parameter for a service area of the multicast or broadcast service. The parameter is essentially a cell list including a plurality of cells. In an example shown in FIG. 2, the cell list corresponding to the service area of the multicast or broadcast service is: a cell 2 (cell2), a cell 3 (cell3), and a cell 4 (cell4). After receiving the session start message, a core network (core network, CN) may identify the cells corresponding to the service area of the multicast or broadcast service, transmit the session start message for the multicast or broadcast service only to a base station corresponding to a related cell in the cell list, and notify the base station of cells that need to participate in transmitting data of the multicast or broadcast service. In the example shown in FIG. 2, a cell 1 and the cell 2 are operated by a base station gNB A, the cell 3 is operated by a base station gNB B, and the cell 4 and a cell 5 are operated by a base station gNB C. Therefore, the core network may notify the gNB A that the cell 2 participates in data transmission of the current multicast or broadcast service, notify the gNB B that the cell 3 participates in data transmission of the current multicast or broadcast service, and notify the gNB C that the cell 4 participates in data transmission of the multicast or broadcast service, thereby controlling a data transmission range of the multicast or broadcast service.

However, some cells have relatively large coverage, such as NTN cells, whose diameter may reach hundreds of kilometers or even thousands of kilometers. The service area of the multicast or broadcast service may be a partial area of a cell (for example, the service area of the multicast or broadcast service is smaller than coverage of an NTN cell). If the transmission manner of the multicast or broadcast service in FIG. 2 is used, an access network transmits data of the multicast or broadcast service within a range of a cell (such as the NTN cell), which may cause a data transmission range of the multicast or broadcast service to be inaccurate.

In order to solve the foregoing problem, an embodiment of the present application provides a wireless communication method, in which a base station may transmit first information to a terminal device to indicate a first service area (such as a partial area of a cell) of a multicast or broadcast service, which is beneficial to accurate controlling of a data transmission range of the multicast or broadcast service. The following describes in detail the wireless communication method with reference to FIG. 3.

FIG. 3 is a schematic flowchart of a wireless communication method according to an embodiment of the present application. A base station in FIG. 3 may also be referred to as a network device, and the network device may be, for example, the network device 110 in FIG. 1. A terminal device in FIG. 3 may be any type of terminal device mentioned above, for example, the terminal device 120 in FIG. 1.

As shown in FIG. 3, in Step S310, receiving, by the terminal device, first information transmitted by the base station. The first information may include information indicating a first service area of a multicast or broadcast service. For example, the first information may be information different from a cell set (or a cell list), in other words, the first information is independent of a cell within a coverage area of the base station.

The first service area may refer to an area range in which the base station transmits data of the multicast or broadcast service to the terminal device. The first service area may be a partial area within a cell of the base station; or the first service area overlaps with a partial area within a cell of the base station.

In some implementations, the first information may include geographic coordinate information of the first service area, and the first information is used to indicate that the first service area is a geographic coordinate area.

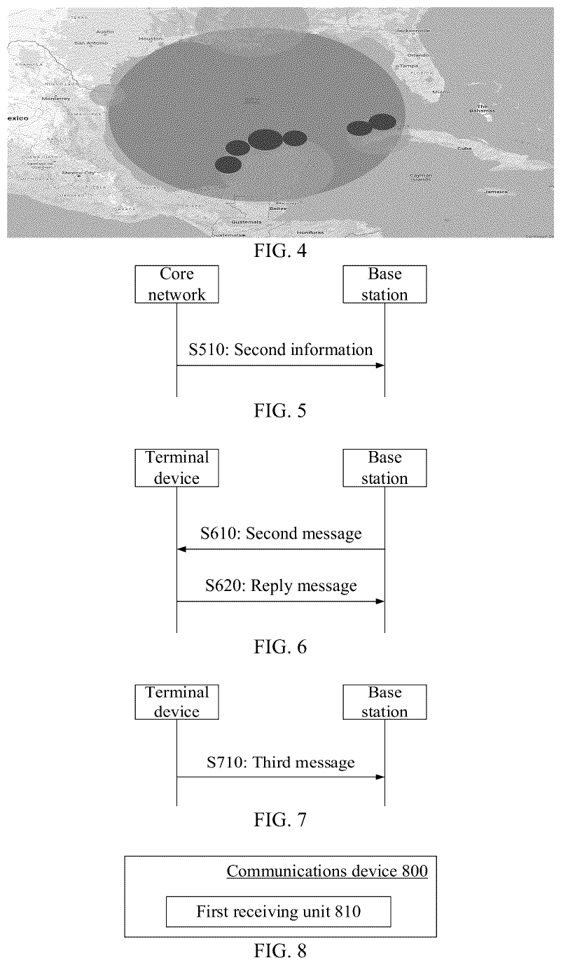

For example, the first information may include a center and a radius of a circle corresponding to the first service area, and the first information may be used to indicate that the first service area is one or more circular areas formed by one or more “centers and radii”, as shown in FIG. 4.

For another example, the first information may include location information on a boundary of the first service area. The location information on the boundary may include, for example, a plurality of boundary coordinate points. The first information may be used to indicate that the first service area is a polygonal area formed by a plurality of boundary coordinate points.

For another example, the first information may include a sector (sector-shaped area) within a cell of the base station and corresponding to the first service area, and the first information may be used to indicate that the first service area is the sector-shaped area.

It may be learned from the foregoing description of the first information, the first information includes location information (such as geographic coordinate information) corresponding to the first service area, rather than a cell list corresponding to the first service area, in other words, the first information is independent of a cell within a coverage area of the base station.

It may be understood that in the transmission manner of the multicast or broadcast service shown in FIG. 2, the service area of the multicast or broadcast service is a plurality of cells. Therefore, the multicast or broadcast service may be transmitted directly in a corresponding cell without notifying the terminal device in the cell of the service area of the current multicast or broadcast service. However, the first service area in this embodiment of the present application may be a partial area of a cell. A terminal device within the cell and outside the first service area may not be able to receive data of the multicast or broadcast service. Therefore, the base station needs to notify a terminal device in the cell of the service area of the current multicast or broadcast service (namely, the first service area), so that the terminal device may determine whether the terminal device supports receiving data of the current multicast or broadcast service.

The manner in which the base station notifies the terminal device in the cell is not specifically limited in the embodiment of the present application. In some implementations, the base station may notify the terminal device through broadcasting. For example, the base station may notify the terminal device in the cell through a system information block (SIB), in other words, the first information is carried in the SIB. For another example, the base station may notify the terminal device in the cell through a multicast broadcast service control channel (MCCH), in other words, the first information is carried in the MCCH.

In some implementations, the first information may be carried by adding a parameter in an existing SIB, or by adding a SIB X to carry the first information. It should be understood that if the SIB contains the parameter added or the SIB X added, it means that the current cell supports performing the multicast or broadcast service in the first service area; if the SIB does not include the parameter added or the SIB X added, it means that the current cell may or may not support performing the multicast or broadcast service in the first service area.

In some other implementations, the first information may be carried by adding a parameter to the MCCH. It should be understood that if the MCCH contains the parameter added, it means that the current cell supports performing the multicast or broadcast service in the first service area; if the MCCH does not include the parameter added, it means that the current cell may or may not support performing the multicast or broadcast service in the first service area.

It should be noted that if the terminal device in the cell does not read the parameter added in the SIB, the parameter added in the MCCH, or the SIB X added, it may be determined by default that entire coverage of the cell belongs to the service area of the current multicast or broadcast service. If the terminal device in the cell reads the first information in the parameter added, the terminal device may determine the service area (namely, the first service area) of the current multicast or broadcast service based on the first information.

In some implementations, the first information is carried in the SIB, and updating of the first information may not trigger a paging message. In other words, if the service area of the multicast or broadcast service is updated, resulting in updating of the SIB, a paging notification procedure is not triggered.

In some implementations, the first information is carried in the MCCH, updating of the first information may not trigger a first message, and the first message is used to notify the MCCH to update. In other words, if the service area of the multicast or broadcast service is updated, resulting in updating of the MCCH, an MCCH updating notification procedure is not triggered.

It should be understood that, for a terminal device that does not support performing the multicast or broadcast service in the first service area, whether the first information is received does not affect behavior of the terminal device.

In some implementations, if there are a plurality of multicast or broadcast services, and the multicast or broadcast services correspond to different service areas, the first information may be used to indicate the service area corresponding to each of the multicast or broadcast services.

It is considered that a terminal device outside the first service area may also be interested in the current multicast or broadcast service. Therefore, in some implementations, the first information includes information indicating whether a terminal device outside the first service area is allowed to apply for receiving data of the multicast or broadcast service. For example, the first information may include a Boolean parameter. If a value of the parameter is 0, it means that a terminal device outside the first service area is allowed to apply for receiving data of the multicast or broadcast service. If a value of the parameter is 1, it means that a terminal device outside the first service area is not allowed to apply for receiving data of the multicast or broadcast service.

In some implementations, the first information includes information indicating that a target terminal device outside the first service area is allowed to apply for receiving data of the multicast or broadcast service. The target terminal device outside the first service area is associated with one or more of the following information: a priority of the terminal device; a target geographic area; or a capability of the terminal device.

In some implementations, the priority of the terminal device may be determined by one or more of: being predefined by a protocol, being configured by a network device, being pre-configured, or the like. The target terminal device may be a terminal device whose priority is greater than a preset threshold. The preset threshold may be configured according to a requirement. This is not specifically limited in the present application.

In some implementations, the target geographic area may be an entire geographic area outside the first service area and within the cell of the base station; or the target geographic area may be a partial geographic area outside the first service area and within the cell of the base station. This is not specifically limited in the present application. The target terminal device may be a terminal device within the target geographic area.

In some implementations, the capability of the terminal device may refer to one or more of the following: the terminal device supporting receiving the multicast or broadcast service, or the terminal device supporting point to point (PTP) communication. The target terminal device may be a terminal device that supports receiving the multicast or broadcast service and supports PTP communication.

In some other implementations, the target terminal device may alternatively be a terminal device having a priority greater than the preset threshold, being located in the target geographic area, and supporting PTP communication for transmitting the multicast or broadcast service.

The foregoing description mainly describes the first information in detail. In some embodiments, the first information may be determined based on second information described below. In some other embodiments, the first information may be equivalent to the second information. The following describes in detail the second information with reference to FIG. 5.

As shown in FIG. 5, in Step S510, transmitting, by a core network device, second information to a base station. The second information is used to indicate a service area of a multicast or broadcast service, and the second information is independent of a cell of the base station.

In some implementations, the second information may include one or more of the following information: a center and a radius of a circle corresponding to the service area of the multicast or broadcast service; or location information on a boundary of the service area of the multicast or broadcast service.

In some implementations, the second information may include geographic coordinate information of the service area of the multicast or broadcast service, and the second information is used to indicate that the service area of the multicast or broadcast service is a geographic coordinate area.

For example, the second information may include the center and the radius of the circle corresponding to the service area of the multicast or broadcast service, and the second information may be used to indicate that the service area of the multicast or broadcast service is one or more circular areas formed by one or more “centers and radii”.

For another example, the second information may include the location information on the boundary of the service area of the multicast or broadcast service. The location information on the boundary may include, for example, a plurality of boundary coordinate points. The second information may be used to indicate that the service area of the multicast or broadcast service is a polygonal area formed by a plurality of boundary coordinate points.

The second information in this embodiment of the present application includes location information corresponding to the service area of the multicast or broadcast service, rather than a cell list corresponding to the service area of the multicast or broadcast service. In other words, the second information is independent of a cell within a coverage area of the base station.

In some implementations, the core network device may refer to an access and mobility management function (AMF) or another network element, such as a session management function (SMF). This is not specifically limited in the present application.

In some implementations, after receiving the second information, the base station may determine the first service area based on the service area of the multicast or broadcast service and coverage of the cell of the base station. For example, if the cell of the base station is a true subset of the service area of the multicast or broadcast service, the first service area may be the cell of the base station. For another example, if the service area of the multicast or broadcast service is a true subset of the cell of the base station, the first service area may be the service area of the multicast or broadcast service, and a service area indicated by the first information is the same as a service area indicated by the second information. For still another example, if there is an overlapping area between the cell of the base station and the service area of the multicast or broadcast service, the first service area may be the overlapping area.

In some implementations, if the first service area is a partial area within a cell, or the first service area overlaps with a partial area within a cell, the base station may resolve the partial area or the overlapping area into one or more sector-shaped areas. To be specific, the cell center is used as a reference point, one sector-shaped area is represented by two angle parameters and two radius parameters, and the first service area may be the sector-shaped area.

The above mainly describes in detail an indication manner and a carrying manner of the first information. The following describes behavior of the terminal device after receiving the first information with an example.

It should be understood that after receiving the first information from the base station, the terminal device may determine the first service area, and then, based on the first service area and current location information of the terminal device, the terminal device may determine whether to receive the data of the multicast or broadcast service.

As an example, if the terminal device is located within the first service area, the terminal device determines to receive the data of the multicast or broadcast service; and if the terminal device is located outside the first service area, the terminal device determines not to receive the data of the multicast or broadcast service.

As mentioned above, the first information is further used to indicate whether a terminal device outside the first service area is allowed to apply for receiving data of the multicast or broadcast service. A case in which the terminal device outside the first service area is allowed to apply for receiving data of the multicast or broadcast service is described below in detail with reference to FIG. 6 and FIG. 7.

Referring to FIG. 6, in Step S610, transmitting, by a base station, a second message to a terminal device. The second message may be used to query whether the terminal device is interested in a multicast or broadcast service.

In Step S620, transmitting, by the terminal device, a reply message for the second message to the base station. The reply message may be used to indicate one or more of the following: the terminal device is not interested in the multicast or broadcast service; or the terminal device is interested in the multicast or broadcast service, and the terminal device is unable to receive the multicast or broadcast service.

It may be understood that the reply message may be used to indicate a reason why the terminal device is unable to receive the multicast or broadcast service, and the reason includes that the terminal device is located outside the first service area.

Referring to FIG. 7, in Step S710, transmitting, by a terminal device, a third message to a base station. The third message is used to request a multicast or broadcast service.

In some implementations, if the first information indicates that the terminal device outside the first service area is allowed to apply for receiving the data of the multicast or broadcast service, the terminal device may transmit the third message to the base station.

In some implementations, the first information further includes information indicating that a target terminal device outside the first service area is allowed to apply for receiving data of the multicast or broadcast service. The target terminal device outside the first service area is associated with one or more of the following information: a priority of the terminal device; a target geographic area; or a capability of the terminal device.

In some implementations, the priority of the terminal device may be determined by one or more of: being predefined by a protocol, being configured by a network device, being pre-configured, or the like. The target terminal device may be a terminal device whose priority is greater than a preset threshold. The preset threshold may be configured according to a requirement. This is not specifically limited in the present application.

In some implementations, the target geographic area may be an entire geographic area outside the first service area and within the cell of the base station; or the target geographic area may be a partial geographic area outside the first service area and within the cell of the base station. This is not specifically limited in the present application. The target terminal device may be a terminal device within the target geographic area.

In some implementations, the capability of the terminal device may refer to one or more of the following: the terminal device supporting receiving the multicast or broadcast service, or the terminal device supporting PTP communication. The target terminal device may be a terminal device that supports receiving the multicast or broadcast service and supports PTP communication.

In some implementations, the target terminal device may alternatively a terminal device having a priority greater than the preset threshold, being located in the target geographic area, and supporting PTP communication for transmitting the multicast or broadcast service.

It should be noted that even if the first information does not indicate that the terminal device is allowed to apply for receiving the data of the multicast or broadcast service, if the terminal device is located outside the first service area, the terminal device may also transmit the third message to the base station.

In some implementations, the third message may include one or more of the following information: location information of the terminal device (for example, location coordinate information of the terminal device); or identity information of the multicast or broadcast service (for example, ID information of the multicast or broadcast service). It should be understood that the base station may transmit data corresponding to the multicast or broadcast service to the corresponding terminal device based on the third message.

It should be noted that the cell within the coverage of the base station in the present application may be an NTN cell, and certainly, may alternatively refer to a TN cell (for example, a TN cell with larger coverage).

The method embodiments of the present application are described in detail above with reference to FIG. 1 to FIG. 7. Apparatus embodiments of the present application are described in detail below with reference to FIG. 8 and FIG. 11. It should be understood that the description of the method embodiments corresponds to the description of the apparatus embodiments, and therefore, for a part that is not described in detail, reference may be made to the foregoing method embodiments.

FIG. 8 is a schematic diagram of a structure of a communications device according to an embodiment of the present application. The communications device 800 shown in FIG. 8 is a terminal device, and the communications device 800 includes a first receiving unit 810. The first receiving unit 810 is configured to receive first information transmitted by a base station, where the first information is used to indicate a first service area of a multicast or broadcast service.

In some implementations, the first service area is a partial area within a cell; or the first service area overlaps with a partial area within a cell.

In some implementations, the first information includes one or more of the following information: a center and a radius of a circle corresponding to the first service area; location information on a boundary of the first service area; or a sector within a cell and corresponding to the first service area.

In some implementations, the first information is further used to indicate whether a terminal device outside the first service area is capable of applying for receiving data of the multicast or broadcast service.

In some implementations, the first information is carried in a system information block SIB or a multicast broadcast service control channel MCCH.

In some implementations, the first information is carried in the SIB, and updating of the first information does not trigger a paging message.

In some implementations, the first information is carried in the MCCH, updating of the first information does not trigger a first message, and the first message is used to notify updating of the MCCH.

In some implementations, the communications device further includes: a determining unit, determining, if the terminal device is located in the first service area, to receive data of the multicast or broadcast service; and/or determining, if the terminal device is located outside the first service area, not to receive data of the multicast or broadcast service.

In some implementations, the communications device further includes: a second receiving unit, receiving a second message transmitted by the base station, where the second message is used to query whether the terminal device is interested in the multicast or broadcast service; and a first transmitting unit, transmitting a reply message for the second message to the base station, where the reply message is used to indicate one or more of the following: the terminal device not being interested in the multicast or broadcast service; or the terminal device being interested in the multicast or broadcast service, and the terminal device being unable to receive the multicast or broadcast service.

In some implementations, the reply message indicates a reason why the terminal device is unable to receive the multicast or broadcast service, and the reason includes that the terminal device is located outside the first service area.

In some implementations, the communications device further includes: a second transmitting unit, transmitting a third message to the base station if the terminal device is located outside the first service area, and/or the first information indicates that a terminal device outside the first service area is capable of applying for receiving data of the multicast or broadcast service, where the third message is used to request the multicast or broadcast service.

In some implementations, the third message includes one or more of the following: location information of the terminal device; or identity information of the multicast or broadcast service.

In some implementations, the first information is independent of a cell within a coverage area of the base station.

In some implementations, a cell within a coverage area of the base station is an NTN cell.

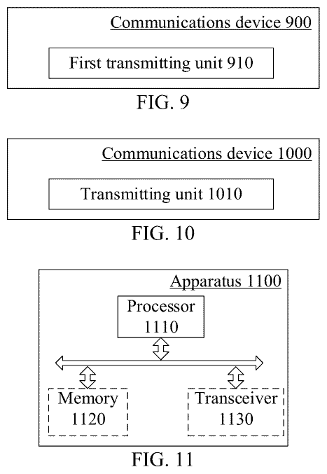

FIG. 9 is a schematic diagram of a structure of a communications device according to an embodiment of the present application. The communications device 900 shown in FIG. 9 is a base station, and the communications device 900 includes a first transmitting unit 910. The first transmitting unit 910 is configured to transmit first information to a terminal device, where the first information is used to indicate a first service area of a multicast or broadcast service.

In some implementations, the first service area is a partial area within a cell; or the first service area overlaps with a partial area within a cell.

In some implementations, the first information includes one or more of the following information: a center and a radius of a circle corresponding to the first service area; location information on a boundary of the first service area; or a sector within a cell and corresponding to the first service area.

In some implementations, the first information is further used to indicate whether a terminal device outside the first service area is capable of applying for receiving data of the multicast or broadcast service.

In some implementations, the first information is carried in a system information block SIB or a multicast broadcast service control channel MCCH.

In some implementations, the first information is carried in the SIB, and updating of the first information does not trigger a paging message.

In some implementations, the first information is carried in the MCCH, updating of the first information does not trigger a first message, and the first message is used to notify updating of the MCCH.

In some implementations, the communications device further includes: a second transmitting unit, transmitting a second message to the terminal device, where the second message is used to query whether the terminal device is interested in the multicast or broadcast service; and the base station receives a reply message that is transmitted by the terminal device for the second message, where the reply message is used to indicate one or more of the following: the terminal device not being interested in the multicast or broadcast service; or the terminal device being interested in the multicast or broadcast service, and the terminal device being unable to receive the multicast or broadcast service.

In some implementations, the reply message indicates a reason why the terminal device is unable to receive the multicast or broadcast service, and the reason includes that the terminal device is located outside the first service area.

In some implementations, the communications device further includes: a first receiving unit, receiving a third message transmitted by the terminal device, where the third message is used to request the multicast or broadcast service.

In some implementations, the third message includes one or more of the following: location information of the terminal device; or identity information of the multicast or broadcast service.

In some implementations, before the base station transmits the first information to the terminal device, the communications device further includes: a second receiving unit, receiving second information from a core network device, where the second information is used to indicate the first service area, and the second information is independent of a cell of the base station.

In some implementations, the second information includes one or more of the following information: a center and a radius of a circle corresponding to the service area of the multicast or broadcast service; or location information on a boundary of the service area of the multicast or broadcast service.

In some implementations, the first information is independent of a cell within a coverage area of the base station.

In some implementations, a cell within a coverage area of the base station is an NTN cell.

FIG. 10 is a schematic diagram of a structure of a terminal device according to an embodiment of the present application. The communications device 1000 shown in FIG. 10 is a core network device, and the communications device 1000 includes a transmitting unit 1010. The transmitting unit 1010 is configured to transmit second information to a base station, where the second information is used to indicate a service area of a multicast or broadcast service, and the second information is independent of a cell of the base station.

In some implementations, the second information includes one or more of the following information: a center and a radius of a circle corresponding to the service area of the multicast or broadcast service; or location information on a boundary of the service area of the multicast or broadcast service.

In some implementations, a cell within a coverage area of the base station is an NTN cell.

FIG. 11 is a schematic diagram of a structure of a communications apparatus to which an embodiment of the present application is applicable. Dashed lines in FIG. 11 indicate that a unit or module is optional. The apparatus 1100 may be configured to implement the method described in the foregoing method embodiments. The apparatus 1100 may be a chip or a communications device.

The apparatus 1100 may include one or more processors 1110. The processor 1110 may allow the apparatus 1100 to implement a method described in the foregoing method embodiments. The processor 1110 may be a general-purpose processor or a dedicated processor. For example, the processor may be a central processing unit (central processing unit, CPU). Alternatively, the processor may be another general-purpose processor, a digital signal processor (digital signal processor, DSP), an application-specific integrated circuit (application specific integrated circuit, ASIC), a field-programmable gate array (field programmable gate array, FPGA) or another programmable logic device, a discrete gate or transistor logic device, a discrete hardware component, or the like. The general-purpose processor may be a microprocessor, or the processor may be any conventional processor or the like.

The apparatus 1100 may further include one or more memories 1120. The memory 1120 stores a program, and the program may be executed by the processor 1110, so that the processor 1110 executes a method described in the foregoing method embodiments. The memory 1120 may be separate from the processor 1110 or may be integrated into the processor 1110.

The apparatus 1100 may further include a transceiver 1130. The processor 1110 may communicate with another device or chip through the transceiver 1130. For example, the processor 1110 may transmit data to and receive data from another device or chip through the transceiver 1130.

An embodiment of the present application further provides a computer-readable storage medium for storing a program. The computer-readable storage medium may be applied to the first network element, the application function network element, or the first communications device provided in embodiments of the present application, and the program causes a computer to perform the methods performed by the first network element, the application function network element, or the first communications device in various embodiments of the present application.

An embodiment of the present application further provides a computer program product. The computer program product includes a program. The computer program product may be applied to the first network element, the application function network element, or the first communications device provided in embodiments of the present application, and the program causes a computer to perform the methods performed by the first network element, the application function network element, or the first communications device in various embodiments of the present application.

An embodiment of the present application further provides a computer program. The computer program may be applied to the first network element, the application function network element, or the first communications device provided in embodiments of the present application, and the computer program causes a computer to perform the methods performed by the first network element, the application function network element, or the first communications device in various embodiments of the present application.

It should be understood that the terms “system” and “network” in the present application may be used interchangeably. In addition, the terms used in the present application are only used to explain the specific embodiments of the present application, and are not intended to limit the present application. In the specification, claims, and accompanying drawings of the present application, the terms “first”, “second”, “third”, “fourth”, and so on are intended to distinguish between different objects, rather than to describe a particular order. In addition, the terms “include” and “have” and any variations thereof are intended to cover a non-exclusive inclusion.

In embodiments of the present application, “indicate” mentioned herein may refer to a direct indication, or may refer to an indirect indication, or may mean that there is an association relationship. For example, A indicates B, which may mean that A directly indicates B, for example, B may be obtained through A; or may mean that A indirectly indicates B, for example, A indicates C, and B may be obtained through C; or may mean that there is an association relationship between A and B.

In embodiments of the present application, “B corresponding to A” means that B is associated with A, and B may be determined based on A. However, it should be further understood that, determining B based on A does not mean determining B based only on A, but instead, B may be determined based on A and/or other information.

In embodiments of the present application, the term “correspond” may mean that there is a direct or indirect correspondence between the two, or may mean that there is an association relationship between the two, or may mean that there is a relationship such as indicating and being indicated, or configuring and being configured.

In embodiments of the present application, “predefined” or “pre-configured” may be implemented by pre-storing corresponding code, tables, or other forms that may be used to indicate related information in devices (for example, including a terminal device and a network device), and a specific implementation thereof is not limited in the present application. For example, being predefined may refer to being defined in a protocol.

In embodiments of the present application, the “protocol” may refer to a standard protocol in the communications field, and may include, for example, an LTE protocol, an NR protocol, and a related protocol applied to a future communications system, which is not limited in the present application.

In embodiments of the present application, the term “and/or” is merely an association relationship that describes associated objects, and represents that there may be three relationships. For example, A and/or B may represent three cases: only A exists, both A and B exist, and only B exists. In addition, the character “/” in this specification generally indicates an “or” relationship between the associated objects.

In embodiments of the present application, sequence numbers of the foregoing processes do not mean execution sequences. The execution sequences of the processes should be determined according to functions and internal logic of the processes, and should not be construed as any limitation on the implementation processes of embodiments of the present application.

In the several embodiments provided in the present application, it should be understood that the disclosed system, apparatus, and method may be implemented in other manners. For example, the described apparatus embodiments are merely examples. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented as indirect couplings or communication connections through some interfaces, apparatus or units, and may be implemented in electronic, mechanical, or other forms.

The units described as separate parts may or may not be physically separate, and parts displayed as units may or may not be physical units, and may be located in one position, or may be distributed on a plurality of network units. Some or all of the units may be selected according to actual requirements to achieve the objectives of the solutions of embodiments.

In addition, functional units in embodiments of the present application may be integrated into one processing unit, or each of the units may exist alone physically, or two or more units may be integrated into one unit.

All or some of the foregoing embodiments may be implemented through software, hardware, firmware, or any combination thereof. When the software is used to implement embodiments, all or some of embodiments may be implemented in a form of a computer program product. The computer program product includes one or more computer instructions. When the computer program instructions are loaded and executed on a computer, the procedures or functions according to embodiments of the present application are completely or partially generated. The computer may be a general-purpose computer, a dedicated computer, a computer network, or another programmable apparatus. The computer instructions may be stored in a computer-readable storage medium or transmitted from one computer-readable storage medium to another computer-readable storage medium. For example, the computer instructions may be transmitted from one website, computer, server, or data center to another website, computer, server, or data center in a wired (such as a coaxial cable, an optical fiber, and a digital subscriber line (digital subscriber line, DSL)) manner or a wireless (such as infrared, wireless, and microwave) manner. The computer-readable storage medium may be any usable medium readable by the computer, or a data storage device, such as a server or a data center, integrating one or more usable media. The usable medium may be a magnetic medium (for example, a floppy disk, a hard disk, or a magnetic tape), an optical medium (for example, a digital video disc (digital video disc, DVD)), a semiconductor medium (for example, a solid state drive (solid state drive, SSD)), or the like.

The foregoing descriptions are merely specific implementations of the present application, but the protection scope of the present application is not limited thereto. Any variation or replacement readily figured out by a person skilled in the art within the technical scope disclosed in the present application shall fall within the protection scope of the present application. Therefore, the protection scope of the present application shall be subject to the protection scope of the claims.

1-70. (canceled)

71. A method performed by a terminal device, comprising:
receiving first information in a system information block (SIB) transmitted by a base station (BS) of a non-terrestrial-network (NTN), wherein the first information comprises information of a first service area of a multicast or broadcast service, wherein the information of the first service area comprises at least one of: a center and a radius of a circle corresponding to the first service area, or a plurality of boundary coordinates of the first service area, and wherein the first service area is a portion of a cell within a coverage area of the BS;
determining the first service area based on the first information;
determining whether the terminal device is located in the first service area based on the information of the first service area; and
receiving the multicast or broadcast service data in response to a determination that the terminal device is located in the first service area.

72. The method of claim 71, wherein the first service area is a polygonal area.

73. The method of claim 71, wherein the first information comprises information associated with a target terminal device, and wherein the method further comprising:
determining, in response to a determination that the terminal device is located outside the first service area, whether the terminal device is the target terminal device based on the first information; and
sending a message to the BS in response to a determination that the terminal device is the target terminal device, wherein the message comprises an indication requesting the multicast or broadcast service.

74. The method of claim 73, wherein the information associated with a target terminal includes at least one of: a target geographic area, a priority level, or device capabilities.

75. The method of claim 73, wherein the message comprises at least one of: location information of the terminal device, or identity information of the multicast or broadcast service.

76. The method of claim 71, wherein the first information comprises a Boolean value indicating whether a terminal device outside the first service area is allowed to request the multicast or broadcast service, and the method further comprising:
sending a message to the BS in response to a determination that the Boolean value is 1, wherein the message comprises an indication of requesting the multicast or broadcast service.

77. The method of claim 71, further comprising:
receiving a query message from the BS; and
transmitting a reply message to the BS in response to the query message, wherein the reply message comprises information indicating whether the terminal device is outside the first service area.

78. The method of claim 77, wherein the reply message further comprises information indicating whether the terminal device is interested in the multicast or broadcast service.

79. The method of claim 71, wherein the cell supports a plurality of multicast or broadcast services, and wherein the first information comprises information of a plurality of service areas, each of the plurality of service areas corresponds to each of the plurality of multicast or broadcast services.

80. A terminal device, comprising:
a transceiver configured to enable wireless communication with a base station (BS) of a non-terrestrial-network (NTN); and a processor communicatively coupled to the transceiver and configured to:
receive first information in a system information block (SIB) transmitted by the BS, wherein the first information comprises information of a first service area of a multicast or broadcast service, wherein the information of the first service area comprises at least one of: a center and a radius of a circle corresponding to the first service area, or a plurality of boundary coordinates of the first service area, and wherein the first service area is a portion of a cell within a coverage area of the BS;
determine the first service area based on the first information;
determine whether the terminal device is located in the first service area based on the location information of the first service area; and
receive the multicast or broadcast service data in response to a determination that the terminal device is located in the first service area.

81. The terminal device of claim 80, wherein the first service area is a polygonal area.

82. The terminal device of claim 80, wherein the first information comprises information associated with a target terminal device, and the processor is further configured to:
determine, in response to a determination that the terminal device is located outside the first service area, whether the terminal device is the target terminal device based on the first information; and
send a message to the BS in response to a determination that the terminal device is the target terminal device, wherein the message comprises an indication requesting the multicast or broadcast service.

83. The terminal device of claim 82, wherein the information associated with a target terminal includes at least one of: a target geographic area, a priority level, or device capabilities.

84. The terminal device of claim 82, wherein the message comprises at least one of: location information of the terminal device, or identity information of the multicast or broadcast service.

85. The terminal device of claim 80, wherein the first information comprises a Boolean value indicating whether a terminal device outside the first service area is allowed to request the multicast or broadcast service, and the processor is further configured to:
send a message to the BS in response to a determination that the Boolean value is 1, wherein the message comprises an indication requesting the multicast or broadcast service.

86. The terminal device of claim 80, wherein the processor is further configured to:
receive a query message from the BS; and
transmit a reply message to the BS in response to the query message, where in the reply message comprises information indicating whether the terminal device is outside the first service area.

87. The terminal device of claim 86, wherein the reply message further comprises information indicating whether the terminal device is interested in the multicast or broadcast service.

88. The terminal device of claim 80, wherein the cell supports a plurality of multicast or broadcast services, and wherein the first information comprises information of a plurality of service areas, each of the plurality of service areas corresponds to each of the plurality of multicast or broadcast services.
